(19) United States
(12) Patent Application Publication
(10) Pub. No.: US 2003/0154593 A1
(43) Pub. Date: Aug. 21, 2003

(54) Method for manufacturing galvanic elements

(75) Inventors: Rainer Hald, Ellwangen (DE); Winfried Gaugler, Ellwangen-Eigenzell (DE); Konrad Holl, Aalen-Dewangen (DE); Peter Haug, Ellwangen (DE); Thomas Woehrle, Ellwangen (DE); Peter Birke, Ellwangen (DE); Dejan Ilic, Ellwangen (DE)

Correspondence Address: IP DEPARTMENT OF PIPER RUDNICK LLP, 3400 TWO LOGAN SQUARE, 18TH AND ARCH STREETS, PHILADELPHIA, PA, 19103, US

(73) Assignee: Varta Microbattery GmbH, a corporation of Germany, Hannover (DE)

(21) Appl. No.: 10/370,933

(22) Filed: Feb. 20, 2003

(30) Foreign Application Priority Data
Feb. 20, 2002 (DE) 102 07 070.9

(51) Int. Cl. H01M 10/04

(52) U.S. Cl. 29/623.1; 29/430

(57) ABSTRACT

A method for manufacturing a galvanic element including forming individual cells including electrode films laminated to a separator, wherein at least one of the electrodes is a lithium intercalating electrode with a polymer matrix in which electrochemically active materials are finely dispersed, wherein the electrochemically active materials are insoluble in the polymer, verifying the function of the individual cells by measuring impedance of the individual cells, and introducing an organic electrolyte into the cells to form the element.

### RELATED APPLICATION

This application claims priority of German Patent Application No. 102 07 070.9, filed Feb. 20, 2002.

### FIELD OF THE INVENTION

This invention relates to a method for manufacturing galvanic elements, which may comprise a number of stacked single cells in an electrolyte in their finished state, wherein the single cells each may consist of electrode films that are laminated to a separator. At least one of the electrodes is a lithium intercalating electrode, in the polymer matrix of which electrochemically active materials that are insoluble in the polymer are finely dispersed.

### BACKGROUND

Rechargeable lithium cells usually either contain an electrode coil or a cell stack consisting of several individual elements. In the case of a coil, a loose connection of electrodes and separators is wound up and only the electrode and the corresponding connection electrode are firmly connected. Cell stacks, on the other hand, are made up of numerous individual cells. The individual cells or elements that make up such a cell stack are a laminate created by connection tabs, an active electrode film, and a separator. Such laminates of rigidly connected individual parts are manufactured in particular as so-called “bicells” with the possible sequences negative electrode/separator/positive electrode/separator/negative electrode or positive electrode/separator/negative electrode/separator/positive electrode because such a symmetric construction prevents tension and bending of the cell during laminating due to the different physical properties of the negative and positive electrode.

An electrode coil, on the other hand, does not allow previous laminating because the total construction would have a thickness that would cause tears in the material when winding it up due to the small bending radii. If the electrodes are designed so thin that such tears do not occur, the ratio between dead material and active material in the cell becomes too unfavorable.

U.S. Pat. No. 5,460,904 discloses a method for manufacturing rechargeable lithium ion batteries. In this method, active materials and additives, such as conductivity enhancer in the electrodes or stabilizers in the separator, a special copolymer, polyvinylidene difluoride hexafluorpropylene (PVDF-HFP), and parts of a plasticizer, typically dibuthyl phthalate (DBP), are mixed thoroughly after adding acetone for dissolving the copolymer and then drawn out to create a film. The electrode films and separator films created in this manner are processed in several laminating processes to create the bicells described above. Several bicells are then layered into a stack. This stack is put into a container, made of deep-drawn aluminum laminated film for example, the container is filled with an electrolyte, sealed with a lid, arranged, and provided with an end closure to create the finished battery.

The construction of galvanic elements from such laminates has considerable advantages. While in a wound cell the contact between separator and electrode is affected even by minor creation of gas, this problem cannot occur in a laminate. Furthermore, such bicells are very well suited for high speed production. The wide variety of shape and construction height is considerably superior to the options of a wound electrode. Extremely thin and large-surface designs are very difficult to realize with a wound electrode.

During production, quality assurance steps are generally necessary. Galvanic elements are tested during manufacturing, for example, by measuring the voltage, capacitance, and resistance. However, these tests are always performed after the production after a completely manufactured galvanic element with electrolyte is created.

It would, therefore, be advantageous to provide a method that allows a quality test during the production of laminated cell stacks as early in the process as possible and, therefore, permit removing defective cells from the manufacturing process as early as possible.

### SUMMARY OF THE INVENTION

This invention relates to a method for manufacturing a galvanic element including forming individual cells including electrode films laminated to a separator, wherein at least one of the electrodes is a lithium intercalating electrode with a polymer matrix in which electrochemically active materials are finely dispersed, wherein the electrochemically active materials are insoluble in the polymer, verifying the function of the individual cells by measuring impedance of the individual cells, and introducing an organic electrolyte into the cells to form the element.

### BRIEF DESCRIPTION OF THE DRAWINGS

One embodiment of the invention is shown in a schematic representation in the drawings and will be described in more detail in the following. The diagrams show:

FIG. 1—a section of an electrode band coming out of the manufacturing system, and

FIG. 2—a Gauss distribution of the absolute value of the impedance measurements.

### DETAILED DESCRIPTION

It will be appreciated that the following description is intended to refer to specific embodiments of the invention selected for illustration in the drawings and is not intended to define or limit the invention, other than in the appended claims.

According to the invention, the performance of individual laminated bicells can be determined by an impedance measurement for alternating voltage or alternating current even before creating a cell stack and, more particularly, before introducing an electrolyte. In the case of cells comprising a number of individual elements, one defective bicell, for example, due to current leakage or poor lamination, makes the entire galvanic element, typically consisting of 5 to 8 parallel bicells, unusable. Testing for short circuits or current leakages with a direct-current resistivity measurement is very difficult because polarization and diffusion effects can influence the measurement heavily. When connecting a direct current, residual water decomposition can cause induced proton conductivity and, thus, a process similar to the formation. As soon as the laminate is finished, there is a reproducibly created system. However, it is not yet activated with an electrolyte at this time. Since there is a separator between the electrodes, it should, therefore, theoretically have infinite resistance in this state. If the laminating quality is not tested, and the verification is only done when the cell stack is finished, the entire stack consisting of 5 to 8 such laminates is rejected even though only a single laminate is defective.

According to the invention, the surprising discovery was made that impedance measurement of such bicell laminates results in finite and closely reproducible impedance values, which can be used as an effective quality criterion. The cause of this finite impedance value is the substances contained in the laminate, such as substances for plastification and/or residual water, which are typically removed only during the following steps of the cell production. These subsequent processing steps include wet-chemical washing and/or thermally activated vaporization of the plastifier, and a vacuum drying step at elevated temperatures, such as 80° C., for minimizing the residual water content.

To determine the impedance of the bicells, a quadrupole measurement can be performed at frequencies from several Hz up to the high kHz range. Advantageous values are between about 100 Hz and about 100 kHz such as, for example, about 1 kHz. When analyzing the measurement, it is advantageous to take into consideration the absolute value and/or the phase angle of the impedance.

The impedance measurement can be done with spring contacts that are in contact with the connection tabs of the laminate or the elements.

It is possible to collect the measured impedance values in a cumulative process. The measured values can be used to create a distribution curve. Individual cells with an impedance outside initially set limits of the distribution curve are then sorted out. The cells that were sorted out can then be marked as reject cells. This can be done by cutting off the connection tab of the laminate, for example.

These and other characteristics of preferred embodiments of the invention are described not only in the claims, but also in the description and the figures, wherein the individual characteristics can be implemented either by themselves or together with others in the form of a sub-combination in an embodiment of the invention and in other areas.

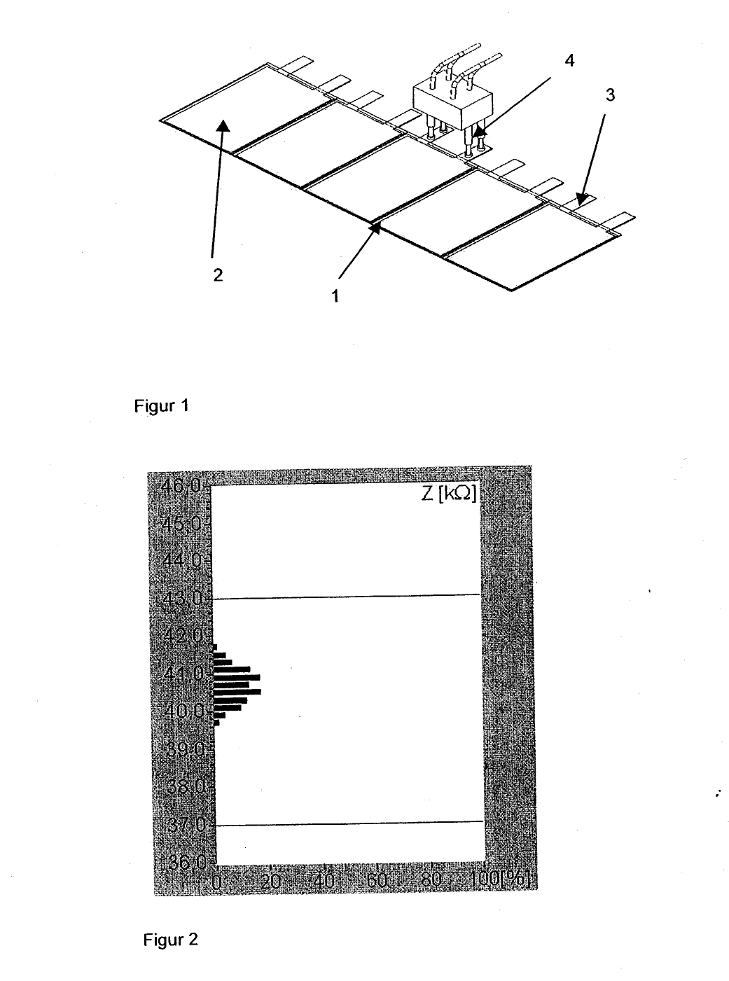

Turning now to the drawings, FIG. 1 shows a section of the electrode band coming out of a manufacturing system, where the electrodes 2 are laminated to a separator 1. The electrodes 2 each comprise active material which is applied to a connection electrode, wherein the connection electrodes are each equipped with connection tabs 3. For the quadrupole impedance measurement, two contacts 4, connected with springs, preferably gold-plated are set onto these connection tabs 3. Singling out of the bicells on the separator band 1 is done by separating the film with a cut through the separator immediately after the impedance measurement according to the invention. Immediately after the measurement, a defective bicell can be marked, for example, by cutting off a connection tab 3, and sorted out. These method steps can be added directly after the manufacturing process of the bicells without any loss of time.

According to the invention, the impedance measuring method can also be used for checking the machine parameters because bicells measured in this manner usually exhibit a sharp Gauss distribution of the absolute values of the impedance values, as it is shown by the example in FIG. 2. The impedance depends on thickness, size, and general chemical and physical properties of the cell constituents, and on machine parameters, such as laminating temperature, pressure and the like. With the measurement according to the invention, the quality of the lamination and the existence of short circuits or current leakage is determined. The bicells can, therefore, be tested for current leakage and short circuits, the quality of the lamination, and the completeness of the bicell constituents with 100% confidence immediately after laminating while the production process is still in progress. Without this testing method, defective bicells are completed to create galvanic elements, and the entire element is recognized as defective and sorted out at the earliest during or after the formation. This is very costly and disadvantageous.

In FIG. 2, the impedance measurements are cumulatively shown. The dependent quantities are the measured impedance values over their relative frequency of occurrence. The limits for rejection in the example are an impedance of about 43 kΩ as the upper and about 37 kΩ as the lower limit. The bicells used here have dimensions of about 6×3 cm² and a thickness of about 550 μm. They are constructed as positive electrode/separator/negative electrode/separator/positive electrode. The active material of the negative electrode is modified graphite in this particular case. The active material of the positive electrode is, for example, a ternary lithium transition metal oxide. Suitable connection tab materials are a copper film for the negative electrode and aluminum stretch metal for the positive electrode. If the cells also contain a plastifier, it is extracted in a following production step, using an n-alcane.

1. a method for manufacturing a galvanic element comprising:
forming individual cells comprising electrode films laminated to a separator, wherein at least one of the electrodes is a lithium intercalating electrode with a polymer matrix in which electrochemically active materials are finely dispersed, wherein the electrochemically active materials are insoluble in the polymer,
verifying the function of the individual cells by measuring impedance of the individual cells; and
introducing an organic electrolyte into the cells to form the element.

2. The method according to claim 1, wherein absolute value and/or phase angle of the impedance is determined.

3. The method according to claim 1, wherein impedance measurement is performed with alternating voltage or alternating current.

4. The method according to claim 1, wherein impedance measurement is performed as a quadrupole measurement with a frequency of about 100 Hz to about 100 kHz.

5. The method according to claim 1, wherein impedance measurement is performed using spring contacts, which establish contact with connection tabs on the laminate.

6. The method according to claim 1, wherein the measured impedance values are accumulated, the test values are used to create a distribution curve, and the individual cells that have an impedance outside the initially set limits of the distribution curve are sorted out.

7. The method according to claim 6, further comprising marking the sorted out cells.

8. The method according to claim 7, further comprising marking the sorted out cells by cutting off a connection tab on the laminate.
